(19) United States
(12) Patent Application Publication
(10) Pub. No.: US 2009/0176315 A1
(43) Pub. Date: Jul. 9, 2009

(54) Microfluidic pl-based molecular sorting

(76) Inventors: Jongyoon Han, Bedford, MA (US); Yong-Ak Song, Waltham, MA (US)

Correspondence Address: Pearl Cohen Zedek Latzer, LLP, 1500 Broadway, 12th Floor, New York, NY, 10036, US

(21) Appl. No.: 11/990,645

(22) PCT Filed: Aug. 16, 2006
(86) PCT No.: PCT/US06/32001

§ 371 Date: Feb. 19, 2008

Related U.S. Application Data
(60) Provisional application No. 60/708,374, filed on Aug. 16, 2005.

(51) Int. Cl. G01N 1/18; B01L 3/00; B03C 9/00

(52) U.S. Cl. 436/177; 422/100; 204/603

(57) ABSTRACT

This invention is directed to methods and devices for separating molecules in a sample, based on differences in their isoelectric point (pI). The methods and devices make use of a diffusion potential created in a microfluidic chamber when a buffered solution comprising molecules, which differ in terms of their isoelectric point (pI) values and a second buffer, which differs from the buffered solution in terms of its pH or salt concentration are introduced in the chamber. The diffusion potential, in turn, enables charge-based separation of the molecules. Applications and permutations of the methods and devices are described.

### FIELD OF THE INVENTION

This invention is directed to methods of pI-based molecular micro-sorting, and devices for accomplishing the same.

### BACKGROUND OF THE INVENTION

Separation of mixtures of complex biomolecules is an important element in high-throughput screening, with simplicity, sensitivity and cost-effectiveness being necessary, yet somewhat elusive goals.

One such application is in proteomics, where very diverse (˜10,000 different species) protein and peptide samples need to be separated and analyzed. The goal of proteomics is to identify and quantitate all of the proteins expressed in a cell, as a means of addressing the complexity of biological systems. Isoelectric focusing (IEF) is a widely used fractionation technique for this purpose, typically as a part of protein 2D gel electrophoresis, where 2D electrophoretic gels are typically analyzed using image analysis techniques to generate proteome maps.

Proteome maps of, for example, normal cells and diseased cells, are compared and proteins that are up- or down-regulated are detected. These proteins may then be excised for identification and characterization, using such methods as mass fingerprinting and mass spectrometry.

Using these methods, however, only the most abundant proteins can be identified, thus most of the proteins identified represent structural or housekeeping proteins, limiting the use of proteomics for the identification of lower abundance proteins.

The lack of sensitivity is caused primarily by a lack of separating or resolving power, since high abundance proteins mask the identification of low abundance proteins. The use of zoom gels (2D gels that focus on a narrow pH range) allows for minimal gains and is considered too cumbersome to be of any practical utility. Selective enrichment methods also can be used but generally at the expense of obtaining a comprehensive view of cellular protein expression. Further, the polyacrylamide matrix typically used in 2DE gives rise to a significant amount of background in the extracted sample mixture making subsequent analysis by MS difficult, and peptide extraction often exposes the sample to various surfaces where sample losses can be substantial, particularly for low abundance proteins.

Thus IEF typically involves the use of a special ampholytes or buffers, is not performed in a continuous manner, is not applicable with high flow speeds, and is not capable of processing both large and small amounts of complex biomolecule samples quickly.

### SUMMARY OF THE INVENTION

In another embodiment, this invention provides an apparatus for molecular sorting, the apparatus comprising:
a. a plurality of inlets;
b. a plurality of outlets; and
c. a microfluidic chamber, in fluid communication with said inlets and said outlets;

According to this aspect of the invention and in one embodiment, the apparatus comprises a non-conductive material, such as glass or PDMS, or in another embodiment, a conductive or semi-conductive material. In another embodiment, the microfluidic chamber comprises an exposed surface which is transparent. In another embodiment, the width of the microfluidic chamber ranges from 5-1000 μm, the length of the microfluidic chamber ranges from 500 μm-8 mm, and the depth of the microfluidic chamber ranges from 1-100 μm

In another embodiment, at least one of the inlets of the apparatus serves for the introduction of a buffered solution comprising molecules, which differ in terms of their isoelectric point (pI) values. In another embodiment, a second inlet serves for the introduction of a second buffer, which differs from the buffered solution in terms of its pH, salt concentration, ionic species contained, solvent used, temperature, solvent viscosity, concentration of buffer additives, or combination thereof.

In another embodiment, a diffusion potential is created in the chamber, enabling a charge-based separation of the molecules in buffered solution. In another embodiment, the molecules which have undergone charge-based separation are collected via the outlets. In another embodiment,

In another embodiment, the second buffer and buffered solution differ in terms of their pH values, and the isoelectric point (pI) values of the molecules range between the pH values. In another embodiment, the second buffer and buffered solution have the same pH value, and the isoelectric point (pI) values of the molecules are above or below the pH value. In another embodiment, the second buffer and said buffered solution differ in terms of their salt concentration. In another embodiment, the buffered solution or second buffer comprise at least one ion in common, which differs in terms of its diffusivity. In one embodiment, the diffusivity ranges from 1E^{-9˜10}E⁻⁹ m²/s. In another embodiment, the buffered solution is flowed through the chamber at a relatively constant flow rate, which in one embodiment ranges from about 0.5-15 μl/minute. In another embodiment, the isoelectric point (pI) values of the molecules being separated may differ by about 0.005.

In another embodiment, the apparatus further comprises electrodes and a means of applying voltage, wherein the electrodes are so positioned such that following application of voltage, an electric field is generated, which is coincident with the field generated by the diffusion potential.

In another embodiment, the apparatus further comprises at least a second microfluidic chamber in fluid communication with inlets and outlets, wherein an outlet of a first chamber serves as a conduit for introducing a buffered solution comprising molecules, which differ in terms of their isoelectric point (pI) values into an inlet of said second microfluidic chamber. In another embodiment, the apparatus comprises a plurality of microfluidic chambers, which in one embodiment are stacked in series, or in another embodiment, are stacked in parallel. According to this aspect of the invention, and in one embodiment, each microfluidic chamber is loaded with buffers, which differs in terms of their pH range.

According to this aspect of the invention and in one embodiment, the apparatus further comprises an inlet into the conduit for introducing an acidic solution, or in another embodiment, a micromixer. In one embodiment, the micromixer comprises inlets, which convey the buffered solution and acidic solution into the micromixer, and an outlet which conveys the mixed solution to the second microfluidic chamber.

In another embodiment, the apparatus further comprises an imaging device, or in another embodiment, an analytical device.

In one embodiment, this invention provides a method of separating molecules in a sample, based on differences in their isoelectric point (pI), the method comprising:
a. introducing a buffered solution comprising molecules, which differ in terms of their isoelectric point (pI) values into an inlet of an apparatus for molecular sorting, the apparatus comprising:
   i. a plurality of inlets;
   ii. a plurality of outlets; and
   iii. a microfluidic chamber, in fluid communication with said inlets and said outlets;
b. introducing into a second inlet in said apparatus a second buffer, which differs from said buffered solution in terms of its pH, salt concentration, ionic species contained, solvent used, temperature, solvent viscosity, concentration of buffer additives, or combination thereof;
c. applying a constant pressure to said buffered solution and said second buffer; and
d. collecting separated molecules from at least one outlet of said chamber;
   whereby a diffusion potential created in said chamber at the interface between said buffered solution and said second buffer enables charge-based separation of said molecules in buffered solution, such that molecules of a particular pI range concentrate at regions of said microfluidic chamber in alignment with an outlet of said chamber.

According to this aspect of the invention, and in one embodiment, the buffered solution or second buffer comprise at least one ion in common, which differs in terms of its diffusivity.

In one embodiment, the molecules are concentrated at an interface between the buffered solution and the second buffer when the molecules comprise pI values, which are in between the pH values of said solutions. In another embodiment, the molecules are depleted from an interface between the buffered solution and the second buffer when the molecules comprise pI values, which are greater or lesser than the pH values of the solutions.

### BRIEF DESCRIPTION OF THE DRAWINGS

FIG. 1 depicts the diffusion-potential-based separation of peptide molecules in a microfluidic channel (left stream: pI 5.1 and light stream: pI 7.2)

FIG. 2 provides a schematic view of a pI-based sorting process and separation of two pI markers with pI values of 5.5 and 6.2, using diffusion potential, at a flow rate of 10 μL/min and where the concentration differs between the markers by 1000. Biomolecules with a pI value which is greater than the pH of the sample buffer are positively charged and focused at the interface between the two buffer flows if the pI value falls between the two buffer pH values. According to the diffusion potential curve, negatively charged molecules are collected on the right side.

FIG. 3 depicts an embodiment of a microsorter. (a) Buffer arrangement of the sorting system. Fluorescent pI marker molecules with a pI value of roughly 5.3 were mixed with two different sample buffers with pH values which differ by roughly 0.1. (b) When the sample buffer pH was 5.25, the molecules were focused in the middle of the channel. (c) When the sample buffer pH was 5.35, the molecules were focused on the right side of the channel.

FIG. 4 schematically depicts an embodiment of a pI-based sorting process. a) pI markers with pI values of 5.1 and 7.2 are separated by the microsorter using a flow rate of 5 μL/min, with a buffer concentration difference with the sheath buffer of 100 and, b) separation of GFP (5 μg/mL) and FITC-labeled ovalbumin (5 μg/mL), with a flow rate of 9 μL/min, when the markers are loaded in a sample buffer pH 5.0, at a concentration difference with the sheath buffer of 500.

FIG. 5 depicts two different modes of operation for pI-based biomolecule sorters. (a) When two buffers with different pH values are used, one can pick out biomolecules within a pI range (5.2˜5.4 in this example). (b) When the buffers with the same pH value are used, one can separate proteins with pI values lower than the pH of the buffer, even at extreme pH values.

FIG. 6 depicts an embodiment of a continuous-flow pI-based sorter, which can span entire pH ranges. This device has a multiple stages of pI-based sorting, shown in FIG. 5b. Each stage separates proteins within the pI region defined by the two buffers used before and after the pI based sorting step.

FIG. 7 demonstrates the measurement of fluorescence intensity using pI marker 6.2 in a pH 5.5 sample buffer, having a concentration difference of 1000 with the sheath buffer. Top (a) and bottom (b) views of the separation channels are shown. The flow rate is 10 μL/min. The intensity profile indicates an increasing sorting efficiency in the channel from the top to the bottom (compare A-A with B-B).

FIG. 8 demonstrates the influence of pH gradient in combination with diffusion potential on microseparation, when the pH value of the sheath buffer is comparable to that of the sample buffer. The pI marker 6.2 is still visible on the right side of the channel with a faint stacking line in the center. The intensity measurement confirms the presence of the molecules with a higher intensity signal on the right side of the channel. When the two intensity graphs, taken from the top (a) and from the bottom (b) of the channel, are compared, decreasing fluorescence intensity is found along the channel indicating a partial diffusion of the pI marker 6.2 to the left buffer.

FIG. 9 demonstrates the influence of an electrical field on the microsorting, in one embodiment of the device, using a mixture of pI markers 5.5 and 6.2 at a flow rate of 6 μL/min. As soon as an electrical voltage of 3 V is applied, the pI marker 5.5 is well focused near the tip of the anode and the gap between the two markers is more readily apparent.

FIG. 10 demonstrates an embodiment of a two-step pI-based sorting of materials with pI range of 6˜7. After the first sorting, the sample is manually titrated with 10 mM HCl and resorted using the same device. In the second run, only the sample stacking in the middle of the channel is collected. The collected sample after the second run is processed via 2D gel electrophoresis to validate the sorting result. By comparing the stained gel picture with that of the original sample, one can determine whether the proteins from the outside of the desired range are still contained in the sorted sample and estimate the sorting efficiency of the process by measuring the intensity of the stained spots.

FIG. 11 demonstrates an embodiment of a single-step pI-based sorting of samples comprising molecules with a pI range of 6˜7. Using three flows, only proteins within the pI range 6-7 are collected from the center outlet while the others with pI<pH 6.0 or pI>pH 7.0 either stack at the boundaries or diffuse into the left buffer stream.

FIG. 12 depicts an embodiment of an array of pI sorters which may be used to sort molecules which differ in terms of the large ranges of their component pI values, in the analysis of a complex sample. In a first step, molecules with pI values of less than 7.0 are collected from the right outlet. In a second step, the sample within the pI range of between 6.9 and 7.0 is collected from the middle outlet and other samples with pI values of less than pH 6.9 are collected from the right outlet again and further processed. Following another separation round, molecules with a pI ranging between 6.8 and 6.9 can be collected from the middle outlet. This approach can be extended to multiple steps to fractionate the sample into several pI ranges with a resolution of 0.1 pH unit.

FIG. 13 demonstrates an embodiment of microsorting in an apparatus using a sheath buffer of 30 mM PSS in 0.1 M phosphate buffer. The buffer generated a high enough diffusion potential to deflect a large protein, B-Phycoerythrin, (molecular weight of 240 kDa) from the middle of the channel to the right outlet when the pH value of the sample buffer was gradually changed from pH 4.6 (B-Phycoerythrin was negatively charged) to pH 4.96 (B-Phycoerythrin was positively charged).

FIG. 14 demonstrates an embodiment of microsorting in an apparatus using a sheath buffer of PSS, which generates a negative potential focusing the positively charged molecules to the middle of the channel and the negatively charged to the left outlet. When PAH was used, the sign of the diffusion potential changes and focusing direction of the molecules changes accordingly.

FIG. 15 demonstrates an embodiment of a continuous-flow two-step sorting approach. The sorting capability was demonstrated via the collection of a single pI marker (pI 6.8) out of a mixture of three pI markers (pI 7.2, 6.8 and 5.5). The coupling between the two sorting steps was realized in an off-line mode with manual titration

FIG. 16 demonstrates an embodiment of an on-line continuous-flow two-step sorting approach and its construction. A, B and D depict methods of construction of the device, and dimensions obtained with this embodiment. C-A mixture of three peptides (pI 7.2, 5.5, 4.0) was sorted into 7.2 and 5.5+4.0, following a first sorting step, with the eluent subsequently titrated down to pH 4.5 using a zigzag-type micromixer and subjected to a second sorting step. The mixture was then sorted into 5.5 and 4.0 or more generally speaking, into two pI groups with pI<4.5 and 4.5<pI<6.2

FIG. 17 demonstrates binary sorting results of a BSA digest sorted in a microsorter run with PSS buffer. The result shows that the peptide with the sequence YLYEI AR was removed from the mixture, when low flow rate was employed.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

This invention provides, in one embodiment, pI-based microsorting devices and methods of using the same.

At the interface between two fluids, each with different ionic composition or concentration, a diffusion potential is created by the differences in the diffusivity between the ionic species for which a concentration gradient exists. The potential, when applied over a small distance in a microfluidic channel with typical sizes between 10˜100 um, is sufficient, as exemplified herein, to promote charge-based separations, for example, of proteins and peptides, in a microfluidic chamber, or on a microfluidic chip.

Such separations were accomplished and exemplified herein, and made use of a pI-based molecular microsorter, as herein described.

In one embodiment, this invention provides an apparatus for molecular sorting, the apparatus comprising:
a. a plurality of inlets;
b. a plurality of outlets; and
c. a microfluidic chamber, in fluid communication with said inlets and said outlets;

In another embodiment, this invention provides an apparatus for molecular sorting, the apparatus comprising:
a. a plurality of inlets, wherein at least one of said inlets serves for the introduction of a buffered solution comprising molecules, which differ in terms of their isoelectric point (pI) values, and at least a second inlet serves for the introduction of a second buffer, which differs from said buffered solution in terms of its pH or salt concentration, ionic species contained, solvent used, temperature, solvent viscosity, concentration of buffer additives, or combination thereof;
b. a plurality of outlets; and
c. a microfluidic chamber, in fluid communication with said inlets and said outlets;
   whereby a diffusion potential is created in said chamber, enabling a charge-based separation of said molecules in buffered solution and said molecules which have undergone said charge-based separation may be collected via said outlets.

The molecules for separation may be positively or negatively charged in solution, when there is a difference between the molecule's isoelectric point (pI) value and the pH value of a solution in which the molecule is found. This specific charge property enables its separation in an electrical field. By flowing two flows with different concentrations of the buffer solutions, or in another embodiment, with different pH, or in another embodiment, containing a different ionic species, or in another embodiment, containing a different solvent, or in another embodiment, maintained at a different temperature, or in another embodiment, containing the same solvent but at a different viscosity, or in another embodiment, containing a different concentration of buffer additives, or in another embodiment, any combination thereof, sufficient diffusion potential is generated and sample mixtures comprising molecules with different pI values may be separated.

It is to be understood that any manipulation of the buffers or buffered solutions of this invention, which in turn, facilitates the slowing down of diffusion in one of the solutions, or facilitates a different diffusive flux of ions in that buffer, is to be considered as part of this invention, for use in the methods, apparatuses and devices thereof.

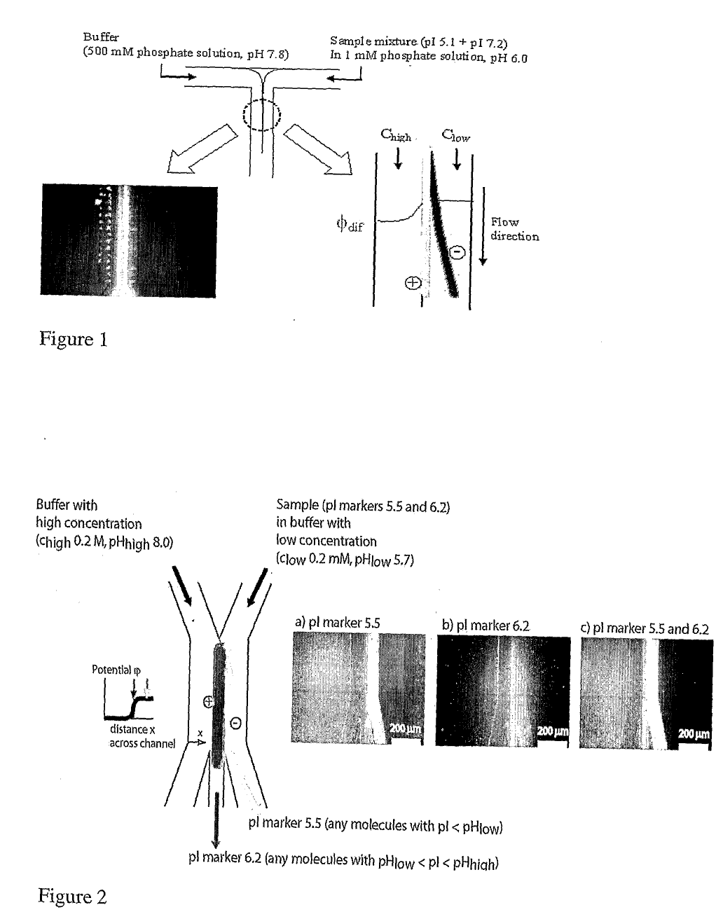

Embodiments of such separations are described and exemplified herein, such as the separation of two substances, with pI's of 5.1 and pI 7.2, in FIG. 1.

In another embodiment, this invention provides a method of separating molecules in a sample, based on differences in their isoelectric point (pI), the method comprising:
a. introducing a buffered solution comprising molecules, which differ in terms of their isoelectric point (pI) values into an inlet of an apparatus for molecular sorting, the apparatus comprising:
   i. a plurality of inlets;
   ii. a plurality of outlets; and
   iii. a microfluidic chamber, in fluid communication with said inlets and said outlets;
b. introducing into a second inlet in said apparatus a second buffer, which differs from said buffered solution in terms of its pH, salt concentration, ionic species contained, solvent used, temperature, solvent viscosity, concentration of buffer additives, or combination thereof;
c. applying a constant pressure to said buffered solution and said second buffer; and
d. collecting separated molecules from at least one outlet of said chamber;
   whereby a diffusion potential created in said chamber at the interface between said buffered solution and said second buffer enables charge-based separation of said molecules in buffered solution, such that molecules of a particular pI range concentrate at regions of said microfluidic chamber in alignment with an outlet of said chamber.

In one embodiment, the terms “apparatus” or “device” are used interchangeably, and represent a structure which comprises the elements herein described.

The molecules for separation may be any which may be distinguished by the methods and via the devices of this invention. In one embodiment, a solution or buffered medium comprising the molecules may be used in the methods and for the devices of this invention. In one embodiment, such solutions or buffered media may comprise natural or synthetic compounds. In another embodiment, the solutions or buffered media may comprise supernatants or culture media, which in one embodiment, are harvested from cells, such as bacterial cultures, or in another embodiment, cultures of engineered cells, wherein in one embodiment, the cells express mutated proteins, or overexpress proteins, or other molecules of interest which may be thus applied. In another embodiment, the solutions or buffered media may comprise lysates or homogenates of cells or tissue, which in one embodiment, may be otherwise manipulated for example, wherein the lysates are subject to filtration, lipase or collagenase, etc., digestion, as will be understood by one skilled in the art, wherein a solution of desired molecules may be obtained and subjected to the methods of this invention.

It is to be understood that any complex mixture, comprising two or more molecules which differ in terms of their isoelectric point, whose separation is desired, may be used for the methods and in the devices of this invention, and represents an embodiment thereof.

In another embodiment, the solutions or buffered media for use according to the methods and for use in the devices of this invention may comprise any fluid, having molecules for separation with the described properties, for example, bodily fluids such as, in some embodiments, blood, urine, serum, lymph, saliva, anal and vaginal secretions, perspiration and semen, or in another embodiment, homogenates of solid tissues, as described, such as, for example, liver, spleen, bone marrow, lung, muscle, nervous system tissue, etc., and may be obtained from virtually any organism, including, for example mammals, rodents, bacteria, etc. In some embodiments, the solutions or buffered media may comprise environmental samples such as, for example, materials obtained from air, agricultural, water or soil sources, which are present in a fluid which can be subjected to the methods of this invention. In another embodiment, such samples may be biological warfare agent samples; research samples and may comprise, for example, glycoproteins, biotoxins, purified proteins, etc.

As will be appreciated by those in the art, virtually any experimental manipulation may have been done on the sample prior to its use in embodiments of the present invention. For example, a variety of manipulations may be performed to generate a liquid sample of sufficient quantity from a raw sample. In some embodiments, gas samples and aerosol samples are so processed to generate a liquid sample containing molecules whose separation may be accomplished according to the methods of this invention.

The apparatuses of this invention comprise, inter-alia, a microfluidic chamber, in which pI-based separation can occur.

In one embodiment, a cause of differential diffusion flux in the microchamber facilitates creation of a diffusion potential. For example, and in some embodiment, changes in pH, concentration of salt, ionic species, solvents used, addition of additives (such as sucrose) to slow down diffusion in one of the streams, temperature, or a combination thereof will result in the creation of a diffusion potential. It will be appreciated by the skilled artisan, that for a given separation procedure, the parameters may be singly, or concurrently modulated to achieve desired separation of the molecules in a particular sample, and such manipulation is within the level of skill in the art, and represents an embodiment of this invention. Similarly, optimization of any of these conditions can be accomplished via routine experimentation with a given set of reagents/buffers, compounds and conditions, which is to be considered as part of this invention. In some embodiments, an additional parameter that may be optimized is the flow rate applied to the apparatuses, and upon introducing the sample buffer or sheath buffer to the microsorting device.

In one embodiment, a microfluidic chip comprises the microfluidic chamber. In one embodiment, the phrase ‘microfluidic chip’ refers to a substrate comprising at least one chamber configured for handling small amounts of fluid, wherein the fluid in on the microliter or nanoliter scale.

In one embodiment, the substrate of the microfluidic chip may be made of a wide variety of materials and can be configured in a large number of ways, as described and exemplified herein, in some embodiments, and other embodiments will be apparent to one of skill in the art. The composition of the substrate will depend on a variety of factors, including the techniques used to create the device, the use of the device, the composition of the sample, the molecules to be sorted, the type of analysis conducted following molecular sorting, the size of internal structures, the presence or absence of electronic components, and the technique used to move fluid, etc. Generally, the devices of the invention should be easily sterilizable as well, although in some applications this is not required. The devices could be disposable or re-usable.

In one embodiment, the substrate can be made from a wide variety of materials including, but not limited to, silicon, silicon dioxide, silicon nitride, glass and fused silica, gallium arsenide, indium phosphide, III-V materials, PDMS, silicone rubber, aluminum, ceramics, polyimide, quartz, plastics, resins and polymers including polymethylmethacrylate, acrylics, polyethylene, polyethylene terepthalate, polycarbonate, polystyrene and other styrene copolymers, polypropylene, polytetrafluoroethylene, superalloys, zircaloy, steel, gold, silver, copper, tungsten, molybdeumn, tantalum, KOVAR, KEVLAR, KAPTON, MYLAR, teflon, brass, sapphire, etc. High quality glasses such as high melting borosilicate or fused silicas may be used, in some embodiments, for their UV transmission properties when any of the sample manipulation and/or detection steps require light based technologies. In addition, as outlined herein, portions of the internal and/or external surfaces of the device may be coated with a variety of coatings as needed, to facilitate the manipulation or detection technique performed.

Structures within such microfluidic chips—including for example, channels, chambers, and/or wells—generally have dimensions on the order of microns, although in many cases larger dimensions on the order of millimeters, or smaller dimensions on the order of nanometers, are used, and represent embodiments of this invention.

In another embodiment, the width of the microfluidic chamber ranges from 5-1000 μm, the length of the microfluidic chamber ranges from 500 μm-8 mm, and the depth of the microfluidic chamber ranges from 1-100 μm.

Microfluidic chips used in the methods and devices of this invention may be fabricated using a variety of techniques, including, but not limited to, hot embossing, such as described in H. Becker, et al., Sensors and Materials, 11, 297, (1999), hereby incorporated by reference, molding of elastomers, such as described in D. C. Duffy, et. al., Anal. Chem., 70, 4974, (1998), hereby incorporated by reference, injection molding, LIGA, soft lithography, silicon fabrication and related thin film processing techniques, as known in the art. In one embodiment, glass etching and diffusion bonding of fused silica substrates may be used to prepare microfluidic chips.

In one embodiment of the invention, microfluidic chips are provided including at least two microfluidic chambers, as further described herein. The microfluidic chambers are so configured, according to this aspect of the invention, to facilitate the sorting of the molecules, based on their differing pI in the channels, and in one embodiment, conveyance of sorted molecules from one microchamber to the next enables serial sorting, based on discrete differences in molecular pI values, as discussed further hereinbelow and as exemplified herein.

In one embodiment, subsequent to separation via the methods and utilizing the devices of this invention, further analysis of the sorted materials is possible. Such analysis may be via direct coupling of the machinery necessary for such analysis to the outlet of a microchamber, as herein described, or in another embodiment, samples are processed separately.

In one embodiment such subsequent analysis may comprise electrophoresis, chromatography, mass spectroscopy, sequencing (for example, for the identification of particular proteins or peptides), NMR and others, as will be appreciated by one skilled in the art.

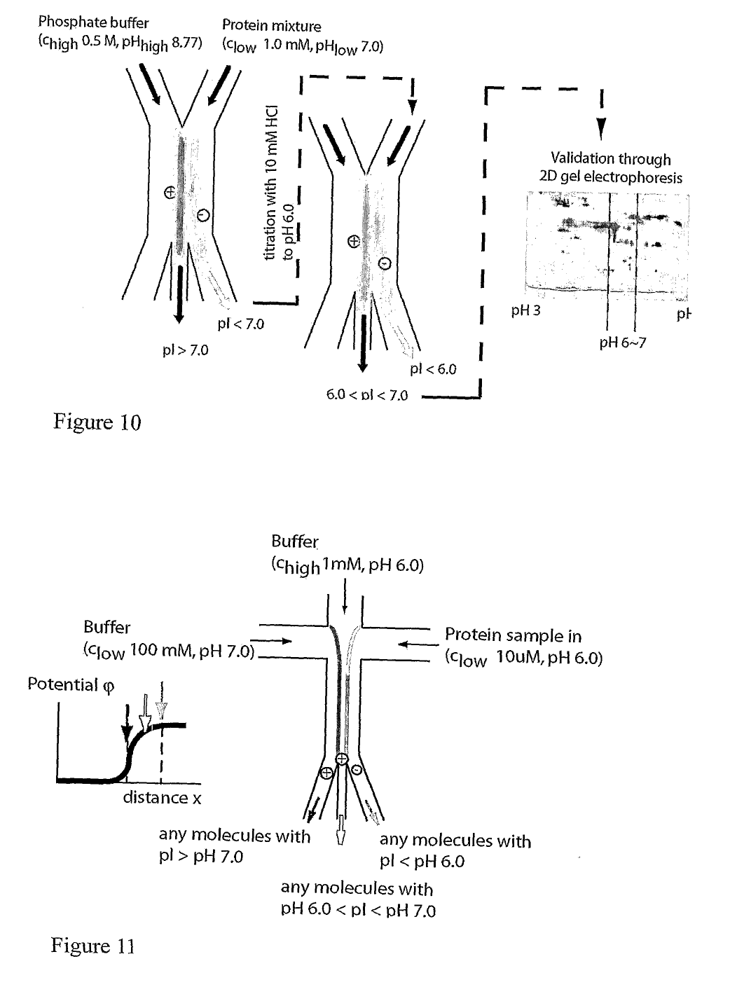

For example, in FIG. 10, where molecules sorted using an embodiment of a microsorting device of this invention having a pI greater than 6 and less than 7, can be further evaluated by 2D gel electrophoresis, or as is shown in the figure, the sorting method, including any permutations of the method, such as, for example, serial sorting as described herein, may be similarly validated.

In another embodiment, prior to, during, or subsequent to the molecular separation or separations, or a combination thereof, imaging of the chamber may be accomplished, which may be via any means known in the art, and may include reflectance mode, or fluorescence microscopy. Imaging may be accomplished over a course of time, and in one embodiment, molecules for separation may be labeled with a detectable marker, for example a fluorescent marker. In one embodiment, anti-quenching agents may be added to the solutions used according to the methods and in the devices of this invention.

For example, in some embodiments, reagents may be incorporated in the buffers used in the methods and devices of this invention, to enable chemiluminescence detection. In some embodiments the method of detecting the labeled material includes, but is not limited to, optical absorbance, refractive index, fluorescence, phosphorescence, chemiluminescence, electrochemiluminescence, electrochemical detection, voltometry or conductivity. In some embodiments, detection occurs using laser-induced fluorescence, as is known in the art.

In some embodiments, the labels may include, but are not limited to, fluorescent lanthanide complexes, including those of Europium and Terbium, fluorescein, fluorescamine, rhodamine, tetramethylrhodamine, eosin, erythrosin, coumarin, methyl-coumarins, pyrene, Malacite green, stilbene, Lucifer Yellow, Cascade Blue™, Texas Red, 1,1′-[1,3-propanediylbis[(dimethylimino-3,1-propanediyl]]bis[4-[(3-methyl-2(3H)-benzoxazolylidene)methyl]]-,tetraioide, which is sold under the name YOYO-1, Cy and Alexa dyes, and others described in the 9th Edition of the Molecular Probes Handbook by Richard P. Haugland, hereby expressly incorporated by reference. Labels may be added to ‘label’ the desired molecule, prior to introduction into the microfluidic chamber, in some embodiments, and in some embodiments the label is added in the microfluidic chamber. In some embodiments, the labels are attached covalently as is known in the art, or in other embodiments, via non-covalent attachment.

In some embodiments, photodiodes, confocal microscopes, CCD cameras, or photomultiplier tubes maybe used to image the labels thus incorporated, and may, in some embodiments, comprise the apparatus of the invention, representing, in some embodiments, a “lab on a chip” mechanism.

In one embodiment, detection is accomplished using laser-induced fluorescence, as known in the art. In some embodiments, the apparatus may further comprise a light source, detector, and other optical components to direct light onto the microfluidic chamber/chip and thereby collect fluorescent radiation thus emitted. The light source may comprise a laser light source, such as, in some embodiments, a laser diode, or in other embodiments, a violet or a red laser diode. In other embodiments, VCSELs, VECSELs, or diode-pumped solid state lasers may be similarly used. In some embodiments, a Brewster's angle laser induced fluorescence detector may used. In some embodiments, one or more beam steering mirrors may be used to direct the beam to a desired location for detection.

In one embodiment, the microfluidic chamber may be constructed of a material which renders it transparent or semitransparent, in order to image the solutions being sorted, or in another embodiment, to ascertain the progress of the sorting, etc. In some embodiments, the materials further have low conductivity and high chemical resistance to buffer solutions and/or mild organics. In other embodiments, the material is of a machinable or moldable polymeric material, and may comprise insulators, ceramics, metals or insulator-coated metals. In other embodiments, the chamber may be constructed from a polymer material that is resistant to alkaline aqueous solutions and mild organics. In another embodiment, the chamber comprises at least one surface which is transparent or semi-transparent, such that, in one embodiment, imaging of the chamber is possible.

The device comprises inlets and outlets in fluid communication with the microfluidic chamber. In one embodiment, the inlet may comprise an area of the microfluidic chip in fluidic communication with one or more channels or chambers. Inlets and outlets may be fabricated in a wide variety of ways, depending on the substrate material of the microfluidic chip and the dimensions used. In one embodiment inlets and/or outlets are formed using conventional tubing, which prevents sample leakage, when fluid is applied to the device, under pressure. In one embodiment, the inlet may further comprise a means of applying a constant pressure, to generate pressure-driven flow in the device.

In one embodiment, the buffered solution is flowed through the chamber at a relatively constant flow rate, which in one embodiment ranges from about 0.5-15 μl/minute. According to this aspect of the invention, pressure applied to the device will be such as to accommodate a relatively constant flow rate, as desired, as will be understood by one skilled in the art.

In one embodiment, any of various mechanisms may be employed to manipulate, transport, and/or move fluid within the device, to convey the fluid within the microfluidic chamber, as well as into or out of the chamber. In some embodiments, pressurized fluid flow is applied from a syringe, or, in another embodiment, other pressure source, attached to, in one embodiment, an inlet of a device of this invention.

In some embodiment, a pressure stop is positioned between two or more channels in an apparatus of this invention, such that the pressure-driven flow through a first microchamber does not influence the flow through a second microchamber, in some embodiments of this invention. According to this aspect of the invention, and in one embodiment, separation may be affected by the pressure applied for the sorting of the molecules within the given microfluidic chamber.

Inlets/outlets allow access to the chambers to which they are connected for the purpose, in one embodiment, of introducing or, in another embodiment, of removing fluids from the chambers on the microfluidic chip. In one embodiment, inlets allow access to the chamber to which they are connected for the purpose of introducing fluids to the microchamber, from a sample reservoir, or in another embodiment, from a sample stored in a conventional storage means, such as a tube. In another embodiment, the outlet allows access of fluid from the microfluidic chamber which has undergone pI-based sorting, according to the methods of this invention. According to this aspect of the invention, the outlet may allow for the removal and storage of the sorted material, or in another embodiment, its conveyance to an analytical module, which in one embodiment, may be coupled thereto.

The methods and devices of this invention rely on the creation of a diffusion potential in the chamber, which enables the charge-based separation of the molecules in buffered solution. In one embodiment, the molecules which have undergone charge-based separation are collected via the outlets and collected in any appropriate container.

As described and exemplified herein, at least one of the inlets of the apparatus serves for the introduction of a buffered solution comprising molecules, which differ in terms of their isoelectric point (pI) values and a second inlet serves for the introduction of a second buffer, which differs from the buffered solution in terms of its pH or salt concentration, or other characteristics, as described herein, or in another embodiment, a second and third inlet serves for the introduction of the second buffer.

Such an arrangement is described and exemplified herein, in FIG. 6. According to this aspect of the invention, and in one embodiment, a three-flow system was employed in the microfluidic device. In this example, the sample flow of two pI markers, e.g., pI=5.1 and 7.2, in a sample buffer with pH 6.0 was focused to the center of the channel using two sodium phosphate buffers of higher ionic strength. Since the sodium ion had a higher diffusion coefficient than the phosphate ion, the center of the channel had a positive potential which decreases towards the boundaries of the sample flow. According to this potential profile, the negatively charged pI marker 5.1 migrated to the middle of the channel, while the positively charged pI marker 7.2 migrated to the outer boundaries of the sample flow. As a result, three stacking lines could be seen in the separation channel, and could thus be isolated or collected.

In another example, loading of GFP (5 μg/mL) and FITC-labeled ovalbumin (5 μg/mL) in 1 mM phosphate buffer with pH 5.0, at a concentration difference of 500 with the second buffer allowed for sorting of the negatively charged GFP to the middle of the channel, while the positively charged ovalbumin was stacked at the boundaries of the sample flow.

In another embodiment, the isoelectric point (pI) values of the molecules being separated may differ by about 0.005. In FIG. 2, a molecule with pI value around 5.3 was re-directed into a different path by changing the pH of the sample buffer as small as ˜0.1 pH units. In some embodiments, the sorting efficiency of molecules which differ by such small differences in pI may be enhanced by any of the means as described herein, including, inter-alia, by stacking many microsorters in series, for repeated collection, as described and exemplified herein.

In some embodiments, sorting of the desired molecules, and their focusing specifically at the interfacial regions between the streams of the solutions may be accomplished, when the molecules have pI values which are between the pH values of the two solutions.

In some embodiments, the molecules are depleted from the interfacial region between the streams of solutions, when the molecules have pI values larger (or smaller) than the pH values of the solutions.

pH differences between the buffer solution comprising the sample to be sorted and the second buffer increase the sorting efficiency, in one embodiment, and sort the charged molecules, for example, proteins and peptides, according to their pI values facilitating their collection.

The methods of this invention enable highly efficient sorting of the molecules, which can be further enhanced, in some embodiments, via the use of a buffer with larger differences in diffusivities between anions and cations in the buffer. According to this aspect of the invention and in another embodiment, the buffered solution or second buffer will comprise at least one ion in common, which differs in terms of its diffusivity, which in one embodiment, may range from about 1E^{-9˜10}E⁻⁹ m²/s. One example of such a buffer is sodium dextran sulfate, or in another embodiment, a Tris buffer.

In another embodiment, sorting efficiency may be enhanced by the application of an external electrical field coincident with the field generated by the diffusion potential.

In one embodiment, the apparatus may further comprise electrodes and a means of applying voltage, wherein the electrodes are so positioned such that following application of voltage, an electric field is generated, which is coincident with the field generated by the diffusion potential. For example, in some embodiments, electrodes are formed on the interior or exterior surfaces of the microfluidic chip and are in electrical communication with the microfluidic chamber.

According to this aspect of the invention, and in one embodiment, a power supply is coupled to the electrodes, which may further comprise a DC-to-DC converter, a voltage-controlled resistor, and a feedback circuit to control the resistor and converter to regulate the voltage of the power supply.

In some embodiments of the present invention, a power module is coupled to an external power supply. In other embodiments, the power module is powered using a portable power supply, such as batteries, solar power, wind power, nuclear power, and the like.

In some embodiments of the present invention, low voltage is delivered to the microchamber. In one embodiment, the term “low voltage” refers to voltage of less than 20V of DC power, or in one embodiment, less than 10V, or in another embodiment, less than 6V, or in another embodiment, 3V, or in another embodiment, less than 3V, or in another embodiment, 1.5 V. In one embodiment, bubble formation in the chamber may be avoided using these voltages.

In one embodiment, the voltage delivered is such that a field strength of up to 3.5×10⁴ V/m is obtained. In one embodiment, an electric field with strength of at least 10 V/m is applied.

In another embodiment, a hybrid approach may enhance the sorting efficiency as exemplified herein. In FIG. 9, pI markers 5.5 and 6.2 in a sample buffer with pH 5.45 and 0.2 mM sodium dextran sulfate. The second buffer used had a higher ionic strength of 0.2 M at a pH value of 5.5 and the separation between the markers was well focused at the tip of the anode, with the distinction between the 5.5 and 6.2 clearly visible, when an external electrical voltage of 3 V was applied.

In one embodiment, the second buffer and buffered solution differ in terms of their pH values, and the isoelectric point (pI) values of the molecules range between the pH values.

In another embodiment, the second buffer and buffered solution have the same pH value, and the isoelectric point (pI) values of the molecules are above or below the pH value. In another embodiment, the second buffer and said buffered solution differ in terms of their salt concentration.

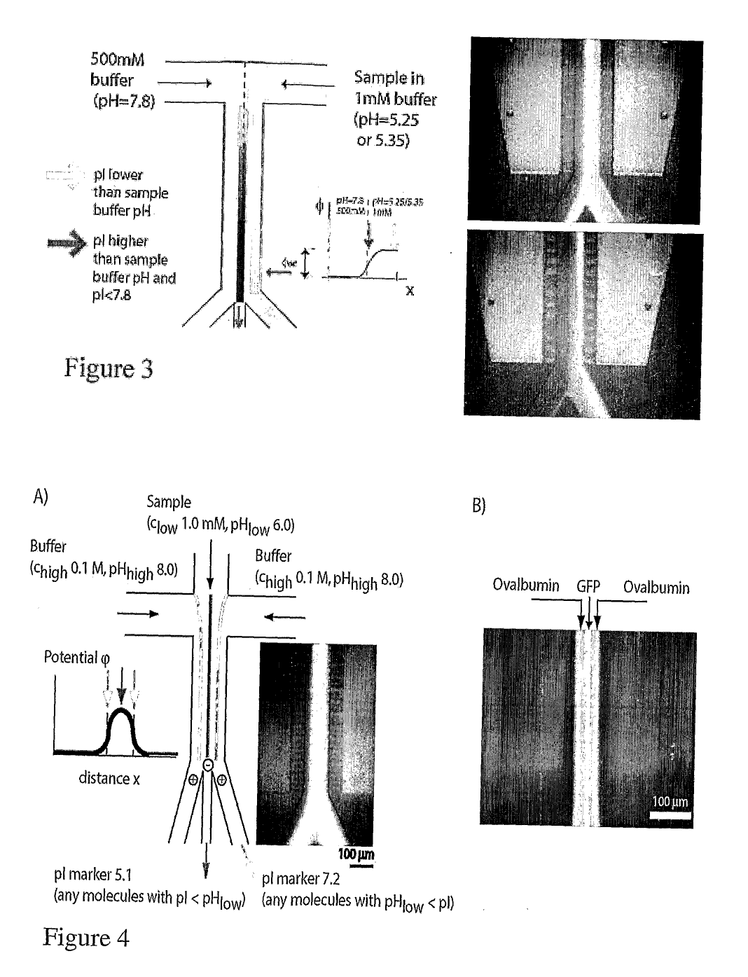

The pI-based biomolecule sorter can be developed, inter-alia, in two different formats, as described, for example in FIG. 3. For detecting one or small number of target biomolecules (biomarkers) out of complex mixture of samples, selective collection of biomolecules within a pI range (around the target molecule pI values) can be achieved by the pI-based sorting shown in panel a, where two buffers with different pH values are used, and the biomolecules have pI values, which fall between the two pH values are continuously focused in the middle of the microchannel and may be thus harvested at the end.

In another format, and representing another embodiment of the invention, when it may be desirable to scan an entire pH range (3-10), for example, in global analysis of a proteome, two buffers with the same pH value, which differ in terms of their concentration are used, as shown in panel b. According to this aspect of the invention, microsorting divides the molecules into two groups, one with a pI higher than, and one with a pI lower than pH value of the buffer.

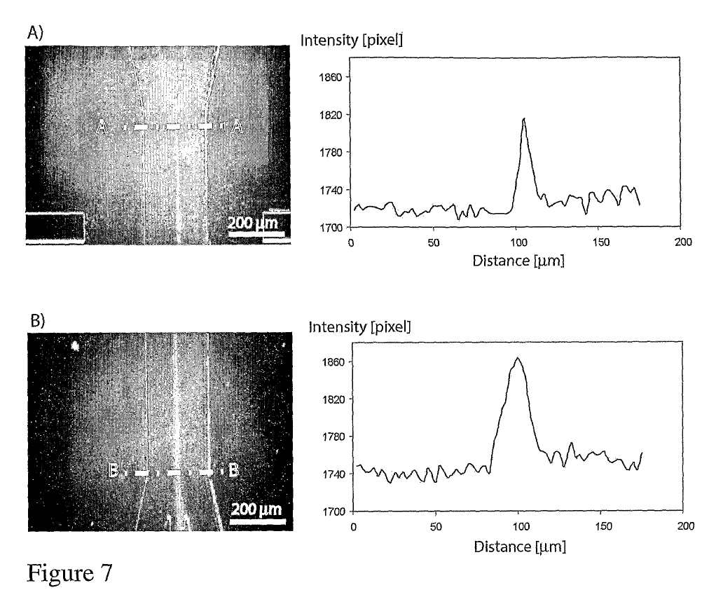

In some embodiments, it is of interest to determine the efficiency of the sorting process according to the methods and using the devices of this invention. In one embodiment, when a fluorescent label is incorporated in the samples being sorted, efficiency may be determined by measuring the fluorescence signal intensity across the micro channel, for example as illustrated in FIG. 7. The intensity measurement in case of pI marker 6.2 shows that it stacks almost completely at the interface to the buffer with a higher ionic strength and pH value of 8.0. The fluorescence signal intensity on the right side of the peak remains almost as low as that of the left side. Further, these measurements indicated that sorting of the biomolecules occurred essentially upon the meeting of the two buffer solutions in the channel. The height of the intensity peak increases along the channel, indicating more stacking of the molecules downstream.

In another embodiment, the apparatus further comprises at least a second microfluidic chamber in fluid communication with inlets and outlets, wherein an outlet of a first chamber serves as a conduit for introducing a buffered solution comprising molecules, which differ in terms of their isoelectric point (pI) values into an inlet of said second microfluidic chamber.

In some embodiments, multiple devices are stacked in series, or in other embodiments, in parallel, wherein the solutions introduced into the microchambers will have progressively different pH values, to allow continuous sorting and collection of molecules based on pI values, over a large pH ranges (2-12).

Embodiments of such an arrangement are exemplified herein, for example, FIG. 4, or FIG. 10.

According to this aspect of the invention and in one embodiment, the apparatus further comprises an inlet into the conduit for introducing an acidic solution, or in another embodiment, a micromixer.

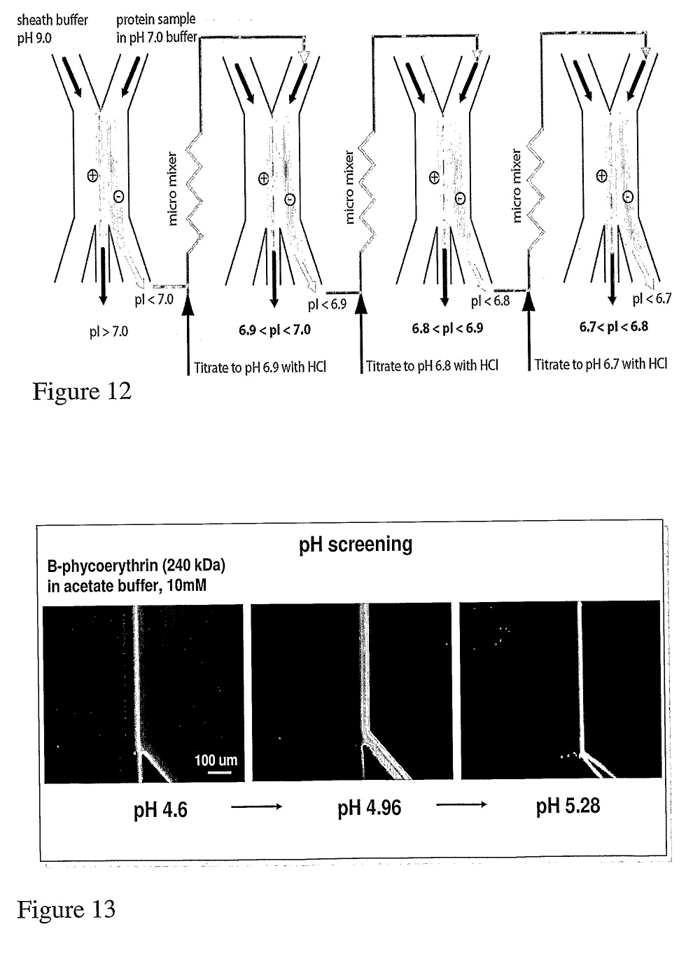

An embodiment of such an arrangement is described herein in FIG. 12. According to this aspect of the invention, and in one embodiment, integration of multiple pI-based microsorters may be accomplished as illustrated, and their use may enable sorting, which can span entire pH ranges. In one embodiment, each stage may separate, for example, proteins within the pI range defined by the two buffers used before and after the sorting step. For integration into an array, in one embodiment, two single microsorters are connected together, in one embodiment, via a micro mixer. In one embodiment, the microsorters are each within a single, self-contained device, or in another embodiment, combined into a single device. In one embodiment, the micromixer comprises inlets, which convey the buffered solution and acidic solution into the micromixer, and an outlet which conveys the mixed solution to the second microfluidic chamber.

According to this aspect of the invention, and in one embodiment, the micro mixer mixes a sorted sample which is passed through an outlet of the first microfluidic chamber, with 10 mM HCl, titrating it to a lower pH value for a subsequent sorting step. After each sort, the mixing and titration may be repeated, and in some embodiments, device comprises multiple microchambers, and attachments to micromixers, etc. In one embodiment, multiple outlets from microchambers of sorted molecules may be connected to a single micromixer, which in turn, may be washed in between each mixing step, and which may comprise a modular design, so that it may deliver mixed and titrated sample to any number of microchambers for subsequent sorting. In another embodiment, each microfluidic chamber is connected to individual micromixers, for example, as depicted in FIG. 12, to minimize cross contamination between sorted samples.

In one embodiment, any type of passive mixer can be utilized for the micromixer. In one embodiment, a zigzag type micromixer, which has a mixing ratio of 80% along 400 μm long channels may be used, as described in, for example, Mengeaud, V. et al. Analytical Chemistry 2002, 74, 4279-4286. In another embodiment, a chaotic mixer as described in, for example, Stroock, A. et al. Science 2002, 295, 647-651, may be used. The efficiency of mixing can be measured with a pH microelectrode, in one embodiment. In one embodiment, serial titrations and mixing according to this aspect of the invention provides for serial sorting of samples, with differences as small as ˜0.1 pI units.

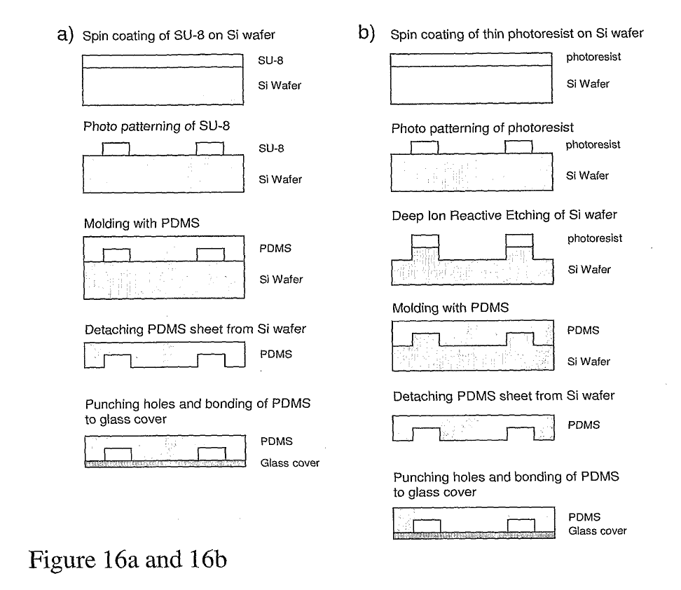

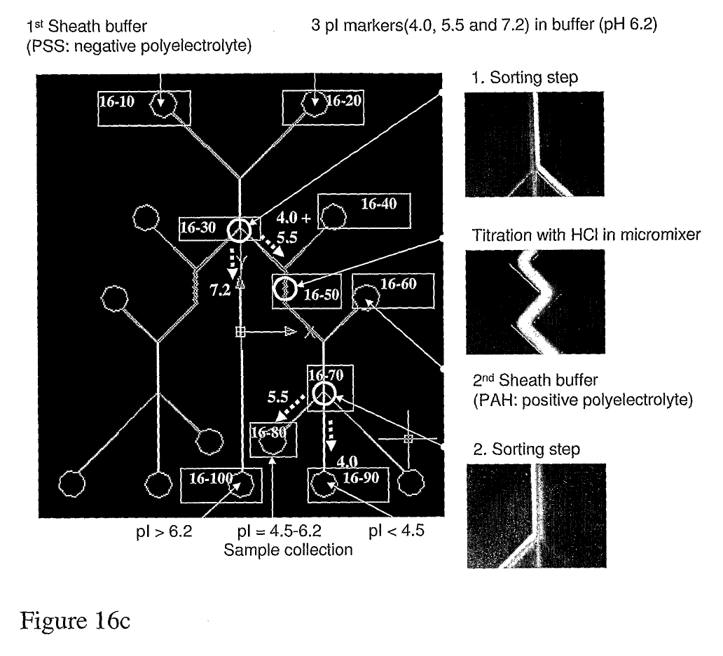

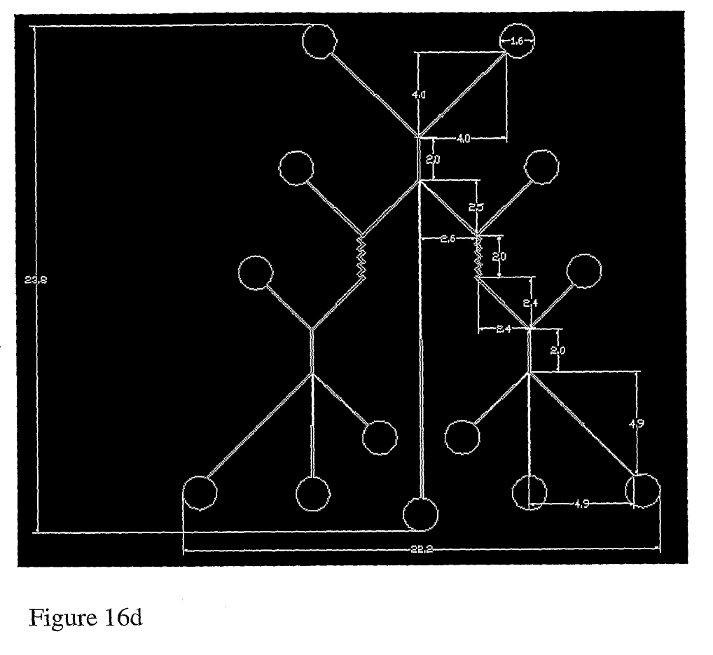

Another embodiment of such a setup is depicted in FIG. 16. An embodiment for an apparatus with on-line coupling for continuous-flow two-step sorting is depicted in this figure. A mixture of multiple compounds, with differing pIs can be sorted in such a setup. For example, in this embodiment, three peptides (pI 7.2, 5.5, 4.0) in buffer (pH 6.2) are introduced to a sample chamber (16-20) and a sheath buffer is introduced into the device via its chamber (16-10). The peptides can be sorted into 7.2 and 5.5+4.0 after the first sorting step in the first microsorter (16-30). Following the first sort, the solution comprising peptides with a pI of 7.2 is conveyed via an outlet to a chamber (16-100). The solution comprising peptides of pI 5.5 and 4.0, respectively is titrated in a zigzag-type micromixer (16-50) down to pH 4.5. A second sorting step is conducted, via the introduction of a second sheath buffer from an inlet (16-60), to a second microsorter (16-70). The mixture is sorted into 5.5 and 4.0, and conveyed via respective outlets to additional chambers for the sorted species (16-80 and 16-90, respectively).

While the sorting after each step, in successive sorting arrays, may involve a certain level of dilution of the initial sample, it can be mitigated by the recollection and concentration of the separated sample downstream, either by trapping column or novel nanofluidic preconcentration device, or other means as will be appreciated by one skilled in the art. It is to be understood that such steps and materials for concentrating the sample may be coupled to the devices of this invention, or used in combination with the same, and represent embodiments of this invention.

A microsorting device of this invention, which enables serial sorting, as described may enable fractionation of complex protein samples such as blood proteomes according to their pI's which in turn, in other embodiments, enhances the detection sensitivity, and, in another embodiment, selectivity of subsequent analysis, such as, for example, MS analysis of the blood proteome, or other complex mixtures. In some embodiments, a pI-based microsorting device of this invention may be further integrated with size-based separation devices, for example, as described in Fu, J. and Han, J. 2004 Micro Total Analysis Systems Conference, Malmo, Sweden, 285-287, or in other embodiments, the microsorter may be integrated with pre-concentration devices, such as a nanofluidic pre-concentration device, such as that described in Wang, Y.-C.; Stevens A. L.; Han J. Analytical Chemistry 2005, 77, 4293-4299, enabling assembly, in some embodiments, of a fully-integrated, multidimensional protein sample preparation device.

In some embodiments, when microfluidic chambers are attached to each other, in the methods and comprising the devices of this invention, the construction may be of modular design, such that specific chambers may be inter-connected to each other, and/or to other modules, such as those for mixing, analysis, imaging, etc., and yet contained within a single housing, in one embodiment. In another embodiment, the design construction is such that numerous arrays can be so constructed, such that any combination of connections may be achieved at a given time. In some embodiments, a plurality of microfluidic chambers, or chips, are provided within a single housing along with a plurality of power supplies and means for detection and/or analysis. In some embodiments, the individual modules can be replaced without removing or exchanging the remaining modules. Dovetail rails and other mechanical assemblies facilitate the swapping of modules in and out, in some embodiments.

In some embodiments, molecular sorting a specific pI range can be accomplished in a single step, for example as illustrated in FIG. 11. Using three flows of two different pH values, e.g. pH 6 and 7, proteins with lower pI values than pH 6.0 stack at the right boundary, while those with pI values between the buffer pH values, here 6˜7, will stay in the middle flow, while others with higher pI values than the buffer upper limit, here 7 will either stack at the left boundary or diffuse further into the left buffer stream. As a result, the sample collected from the center outlet would contain only proteins within a pI range between the two buffer pH values, e.g. 6˜7.

In some embodiments, the pI-based separation can be performed in a microfluidic channel without any external power supply, which offers some advantages to the invention, in terms of its simplified design and minimized cost associated with construction of such equipment.

In another embodiment, an advantage to the methods and devices of this invention is the ability to sort molecules based on their pI, without need for special ampholytes or other gels, minimizing complications to the integration of the microsorter with other analytical modules, for example in “lab on a chip” applications.

Another aspect of the invention, which is advantageous, is the ability to use a variety of different buffers and pH conditions, even very basic or acidic pH conditions, which are typically problematic for use in conventional charge-based separations. Further advantages offered is the high-throughput sorting and subsequent analysis offered in the methods and devices of this invention, since separation may be performed in a continuous manner, achieving flow rates of at least between 1˜9 μl/min, and potentially as great as 100 μl/min.

Sample preparation is a major challenge for current proteomic biomolecule detection and analysis, which requires purification and sorting of a complex biomolecule sample (such as serum /urine) which contains more than ˜10,000 different protein species and over ˜9 orders of concentration ranges. The methods and devices for (pI)-based separation of the present invention provides an effective tool for proteomic sample simplification, since the pI of a given target biomarkers or signaling molecules can be easily estimated from the sequence.

The methods and devices for (pI)-based separation of the present invention are applicable, inter-alia, in general proteomics applications, even when used as a standalone microfluidic system (without integration). The flow rate of the system is high enough to be used to process large biosamples quickly, in typical sample volumes used in any bioanalysis. Further, another advantage to the methods/devices of this invention is the lack of a need for membranes, which can contribute to sample loss. There is also no need for carrier ampholytes, thus little background caused by use of these special molecules. In fact, in some embodiments of the invention, microsorting may be accomplished via the methods/devices of this invention, even when using volatile buffers, which are typically used in mass spectrometry, thus their use in the sorting may further the “lab on a chip” applications.

The following Examples serve to illustrate some embodiments of the invention, and are not to be construed as limiting the invention in any way.

### EXAMPLES

### Example 1

### pI-Based MicroSorting

At the interface between two fluids with different ionic compositions or concentrations, a diffusion potential is created by the differences in the diffusivity between the ionic species for which a concentration gradient exists. Although small in its absolute value (typically in the mV range), this potential can be sufficient when applied over a small distance in a microfluidic channel with typical sizes between 10˜100 um.

It was therefore of interest to test whether a diffusion-driven potential may be exploited for charge-based separations of proteins and peptides on a microfluidic chip.

Since as zwitterions, the protein or peptide molecule can be either positively or negatively charged, depending on the difference between its isoelectric point (pI) value and the pH value of the buffer solution, such molecules may be separated in an electrical field.

Toward this end, a microfluidic sorting device was constructed, two fluids with different concentrations of sodium phosphate buffer solutions were introduced into the device, where one buffer solution also contained a sample mix consisting of marker compounds with a pI of 5.1 and 7.2, and separation of the compounds was determined, indicating also whether sufficient diffusion potential was generated, to enable the separation (FIG. 1).

When a sample buffer having a pH value of 6.0 was used, the pI 5.1 marker was negatively charged and therefore concentrated at the interface between the two fluids, whereas the positively charged pI 7.2 marker migrated toward the positive potential on the right side. The flow rate used was 6 μl/min.

Sorting of two pI markers (peptides), pI 5.5 and 6.2, in buffer solution with pH 5.78 using a two-flow system was also accomplished, in another format of the microsorter, as shown in FIG. 2. Focusing of the two pI markers 5.5 and 6.2 separately, and as a mixture is shown. As in the previous case, the negatively charged pI marker 5.5 is deflected to the right side of the channel, whereas the positively charged pI marker 6.2 is focused in the opposite direction at the center of the channel. Since the sheath buffer has a higher pH value of 8.0, the pI marker 6.2 is stacked at the interface of the two buffers.

The pI resolution of the technique was approximately 0.1 pH, which is the typical requirement for a proteomic sample preparation. In FIG. 3, a molecule with pI value around 5.3 was re-directed into a different path by changing the pH of the sample buffer by as few as ˜0.1 pH units. While a weak background signal was evident (FIGS. 3b & 3c), suggestive of a less than 100% recovery rate (sorting efficiency), this may readily be overcome by the use of multiple sorters in series, for repeated collection, should high efficiency be necessary.

When two pI markers, pI=5.1 and 7.2, were introduced in a sample buffer pH 6.0 to a microfluidic device (FIG. 4), the 5.1 marker was focused to the center of the channel with the two sodium phosphate buffers of higher ionic strength. FIG. 4A shows a schematic of the diffusion-potential-driven separation with the corresponding potential profile. Since the sodium ion had a higher diffusion coefficient than the phosphate ion, the center of the channel had a positive potential which decreased towards the boundaries of the sample flow. According to this potential profile, the negatively charged pI marker 5.1 migrated to the middle of the channel, while the positively charged pI marker 7.2 migrated to the outer boundaries of the sample flow. As a result, three stacking lines were seen in the separation channel.

Protein separation using the microsorters was accomplished, using GFP (pI ˜4.9, MW 27 kD, 5 μg/mL) and FITC-labeled ovalbumin (pI˜5.1, MW 45 kD, 5 μg/mL) and the microsorter, as shown in FIG. 4B. In a 1 mM phosphate buffer at pH 5.0, the negatively charged GFP was focused in the middle of the channel, while the positively charged ovalbumin was stacked at the boundaries of the sample flow, indicating that the microsorting technique can be applied to both proteins and peptides.

### Example 2

### Other Examples of pI-Based Micro-Sorters

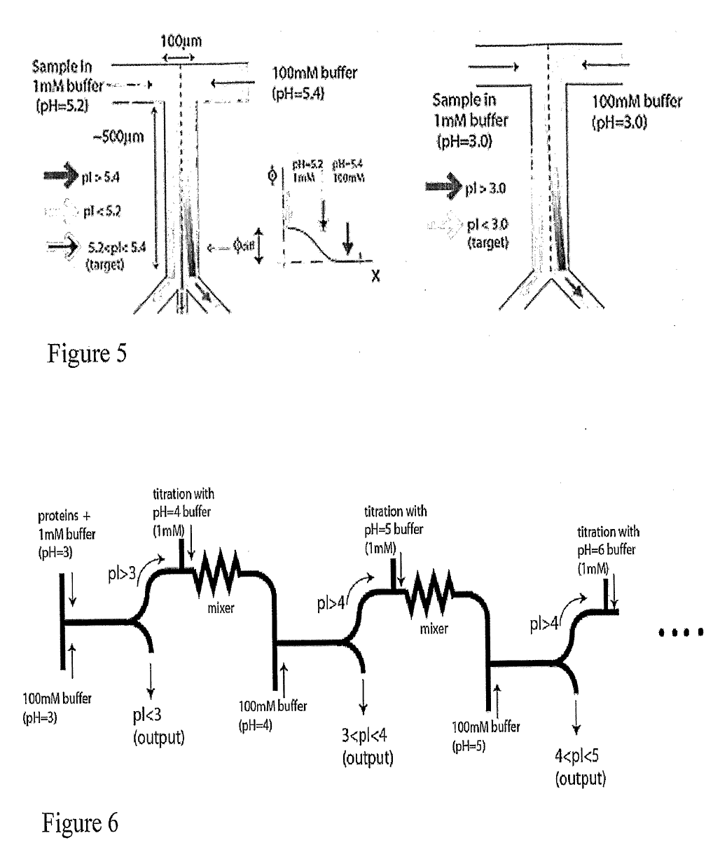

pI-based biomolecule sorters were developed in two different formats, as shown in FIG. 4. For detecting one or small number of target biomolecules (biomarkers) out of complex mixture of samples, selective collection of biomolecules within a pI range (around the target molecule pI values) becomes important, and this can be achieved by the pI-based microsorter shown in FIG. 5a. In this format, one uses two buffers with different pH values, and the biomolecules with pI values falling in between the two pH values are continuously focused in the centrally within the microchannel and harvested.

It is of interest at times to scan an entire pH range (3-10) for global analysis of a proteome. For such applications, a pI-based biomolecule microsorter can be used, where two buffers with the same pH value are introduced to the sorter, as shown in FIG. 5b. In this format, the sorter separates proteins or peptides into two groups (one group comprises proteins/peptides which have a pI higher than the buffer pH and the other has a lower pI, or vice versa).

It is possible to stack the microsorters in a series, as shown in FIG. 6, to sort a large group of proteins, for example, entire proteomes, based on the pI ranges. The scheme displayed shows that after each pI-based sorting, the sample buffer may be re-titrated to different pH values for additional separation.

The operation of the microsorters relies upon the pressure-driven flow of several buffers (with predefined pH values) within the microchannel. The selection resolution, pI ranges, and the efficiency of the separation are all controlled by the buffer solutions used in the system.

### Example 3

### Microsorting Efficiency

Measuring fluorescence signal intensity across the channel of a microsorter enables the estimation of the efficiency of the sorting process. Fluorescence intensity measurements obtained for a pI marker 6.2 (FIG. 7) shows that it stacks almost completely at the interface with buffer with a higher ionic strength and pH value of 8.0. Fluorescence signal intensity on the right side of the peak remains almost as low as that on the left side.

Timing of the sorting may also be determined in measuring intensity, where one can observe sorting occurring immediately following mixing of the two buffer solutions in the channel. The height of the intensity peak increases along the channel, indicating more stacking of the molecules downstream.

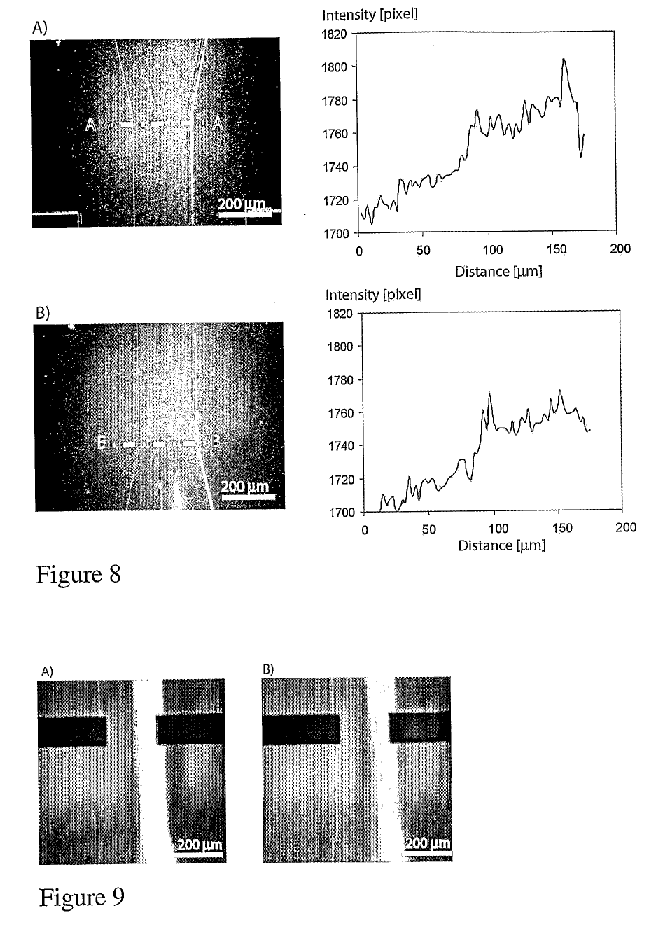

The pH difference between the sample buffer and the sheath buffer was found to be essential for increasing sorting efficiency and sorting charged proteins and peptides according to their pI values. Stacking effects at the boundary, due to the pH gradient was found to be useful for highly efficient sorting, as shown in FIG. 7. To demonstrate effects of the pH difference, the pH value of the phosphate buffer with a high ionic strength was reduced from 8.0 to 5.5, with the low-concentration sample buffer having a pH value of 5.35. The well-defined stacking line is no longer visible in the middle of the channel, FIG. 8. Also, the molecules, previously stacked to the centerline of the channel when the pH value of the sheath buffer was 8.0, are visible on the right side indicating low sorting efficiency.

In order to increase sorting efficiency, two different strategies were developed. In one, a higher diffusion potential was sought, by using a buffer with larger differences in diffusivities between anions and cations, for example, sodium dextran sulfate, which has a more substantial difference in the diffusivities of the component species, Di=1.33⁻⁵ cm²/s for Na⁺ and Di=0.64⁵ cm²/s for dextran sulfate.

The second strategy was to employ an external electrical field superimposed to the field generated by the diffusion potential.

The effect of these strategies on the sorting efficiency is shown in FIG. 9. pI markers 5.5 and 6.2, in sample buffer containing 0.2 mM sodium dextran sulfate at pH 5.45 were loaded in a microsorter, with a sheath buffer having a higher ionic strength of 0.2 M and pH value of 5.5, and sorting was determined in the absence (a) or presence (b) of an electrical field.

The separation between the markers when no field was applied (i.e. driven only by the diffusion potential) was not readily apparent. Following the application of an external electrical voltage of 3 V applied through the 100 μm wide and 150 nm thick electrodes, the pI marker 5.5 was well focused at the tip of the anode and the distinction between the 5.5 and 6.2 was clearly visible.

### Example 4

### Serial Sorting of Molecules with pI-Based Microsorting

pI based microsorting may be effectively used for sorting mixtures into one specific pI range. For example, if it is desirable to collect all proteins which have a pI between 6 and 7, then a strategy such as that outlined in FIG. 10 may be employed. Toward this end, a sample is diluted in a phosphate buffer with pH 7.0, and all the proteins with pI values less than 7.0 are collected on the right outlet and then manually titrated with 10 mM HCl to pH 6.0. The titrated sample is then sorted on the device again, however, in the second run, only the sample stacking in the middle of the channel is collected, since this sample will have the desired pI range of 6˜7. Thus, the targeted pI range of separation can be selected simply by changing the pH value of the buffers used in the device.

In some instances, however, sorting of proteins and peptides into a specific pI range may be accomplished in a single step, for example as illustrated in FIG. 11. Using three flows of two different pH values, e.g. pH 6 and 7, proteins with lower pI values than pH 6.0 are stacked at the right boundary. Among the proteins diffused into the middle flow, only those with pI values between 6˜7 stay in the middle flow, while others with pI values higher than 7 will stack at the left boundary or diffuse further into the left buffer stream. As a result, the sample collected from the center outlet contains only proteins within the pI range 6˜7.

The degree to which the sample mixture has been effectively sorted into a specific pI range can be validated by the standard 2D gel electrophoresis.

It is also possible to integrate multiple single pI sorters spanning a specific pH range (FIG. 12). Successive sorting of proteins within a pI range defined by the two buffers used before and after the sorting step is conducted, using devices integrated into an array. The devices may be connected together via a micro mixer, which mixes the sorted sample with 10 mM HCl, titrating it to a lower pH value for subsequent sorting.

The micromixer may be a passive mixer, of a zigzag type, which has a mixing ratio of 80% along 400 μm long channels [Mengeaud, V.; Josserand, J.; Girault, H. Analytical Chemistry 2002, 74, 4279-4286], or a chaotic mixer [Stroock, A.; Dertinger S.; Ajdari, A.; Mezic, I.; Stone, H.; Whitesides, G. Science 2002, 295, 647-651] may be used.

The multiple sorting device affords the possibility of fractionating complex protein samples such as blood proteome according to their pI's providing a relatively high detection sensitivity and selectivity for subsequent MS analysis of a blood proteome.

It is also possible that the pI sorting devices exemplified herein be integrated within size-based separation devices [Fu, J.; Han, J. 2004 Micro Total Analysis Systems Conference, Malmo, Sweden, 285-287] or nanofluidic pre-concentration devices [Wang, Y.-C.; Stevens A. L.; Han J. Analytical Chemistry 2005, 77, 4293-4299], where fully-integrated, multidimensional protein sample preparation devices can be thus constructed.

### Example 5

### Sorting of Large Proteins with Use of Buffers Having a High Diffusion Potential

It was of interest to determine whether diffusion-potential-driven pI-based sorting of large proteins could be readily accomplished. Toward this end, it was of interest to determine whether the use of polyelectrolytes as a source of the diffusion potential would be useful. One of the advantages of the use of the polyelectrolytes is that due to the higher difference in the diffusion coefficients of the polyelectrolyte ions, a higher diffusion potential is achievable than with the use of conventional salt buffers. For instance, the diffusion coefficient of PSS− ion, D=6.7×10⁻⁸ cm²/s, is three orders of magnitude smaller than that of sodium ion with D=1.33×10⁻⁵ cm²/s. For comparison, the diffusion coefficient of phosphate ion, H₂PO₄⁻, is D=9.5×10⁻⁶ cm²/s. Because of this large difference, a diffusion potential of 104.2 mV at a concentration difference of 60 is obtained, compared to 22.61 mV in the case of the sodium phosphate buffer at a concentration difference of 200. Among several commercially available polyelectrolytes, we used PSS (poly sodium styrene sulfonate) as a negative polyelectrolyte and PAH (poly allyamine hydrochloride) or PDDA (poly diallyldimethylammonium chloride) as a positive polyelectrolyte, alternatively. The net charge of PAH is pH-dependent, whereas the PDDA is not influenced by the pH value. Another important characteristic of the polyelectrolyte regarding the sorting application is that the net charge can be varied with an additional salt in the buffer such as NaCl. This in turn provides for the tuning of the diffusion potential across the liquid junction depending on the molecules applied.

FIG. 13 demonstrates sorting of B-Phycoerythrin (a protein with a high molecular weight of 240 kDa) in a microsorter, when a sheath buffer of 30 mM PSS and 0.1 M phosphate buffer was used. The protein was deflected from the middle of the channel to the right outlet when the pH value of the sample buffer was gradually changed from pH 4.6 (B-Phycoerythrin was negatively charged) to pH 4.96 (B-Phycoerythrin was positively charged), while use of a standard sodium phosphate buffer did not yield any change in protein localization, upon gradual pH change of the buffers employed.

### Example 6

### Sorting Direction Changes as a Function of the Choice of Sheath Buffer

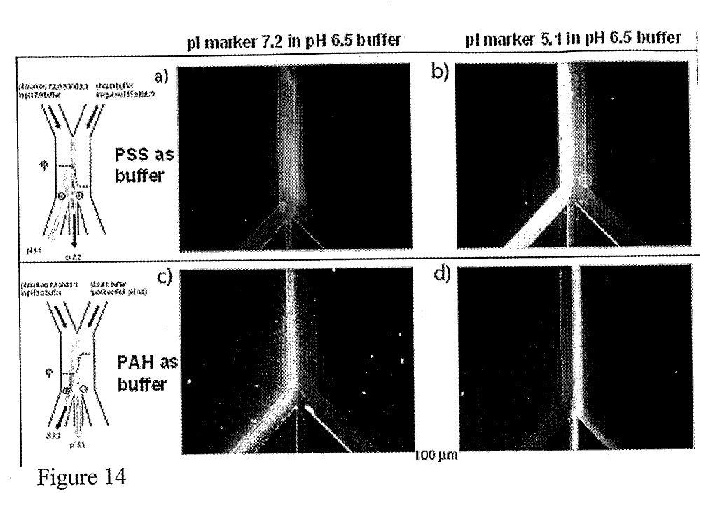

The choice in the use of a PSS(−) or PAH(+) buffer enables the changing of the polarity of the diffusion potential across the liquid junction. Depending on the sheath buffer used, the localization of where the charged peptides were focused inside the microchannel alternated (FIG. 14). The positively charged peptides (pI marker 7.2 in pH 6.5 buffer) were focused to the middle (a) of the channel and the negatively charged pI marker 5.1 to the left outlet (b) when PSS was used as sheath buffer. If, however, the PAH was used as the sheath buffer, the positive peptides were focused to the left outlet and the negative peptides to the middle of the microchannel.

While the PSS buffer generated a negative potential which focused the positively charged molecules to the middle of the channel and the negatively charged to the left outlet, in case of PAH, the sign of the diffusion potential changed. Changes with use of PAH were due to the higher diffusion coefficient of the chloride ion compared to that of the polyallyamine ion. The focusing direction of the molecules changed accordingly.

Thus the polarity of the diffusion potential can be changed as a function of the choice of sheath buffer.

### Example 7

### Two Step Sorting of Large Proteins with Use of Buffers Having a High Diffusion Potential

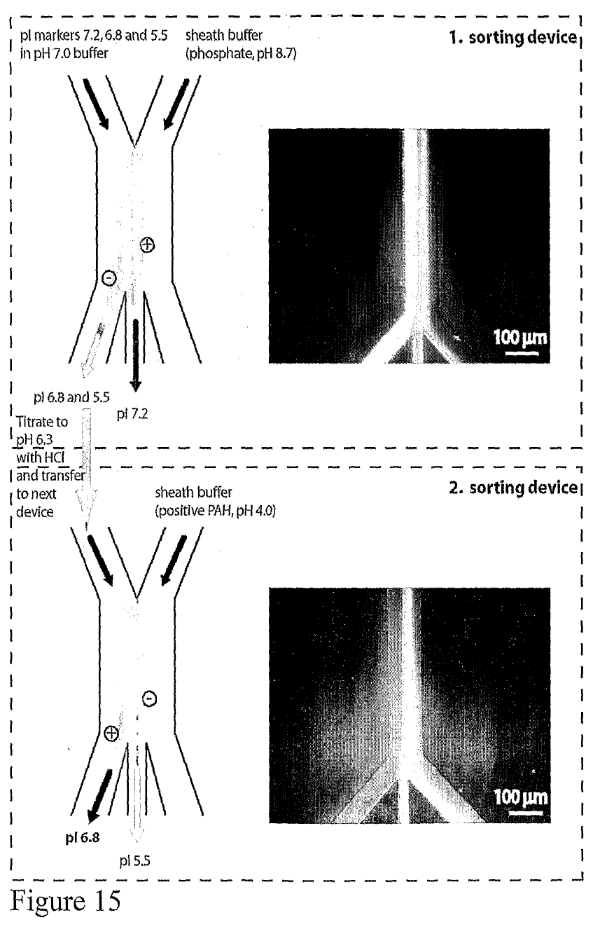

Using this combination of the positive/negative polyelectrolyte or positive/negative salt buffers such as sodium phosphate/Tris-HCl, or negative salt buffer/positive polyelectrolyte (and vice versa), we realized a two-step sorting scheme for proteins and peptides by coupling two sorting steps. The coupling can be performed either off-line or on-line. In case of an off-line coupling, we need to collect the sample out of the sorting device first, titrate it down to a desired pH value manually and then run the second sorting step in another sorting device. Alternatively, an on-line coupling can be realized by connecting two sorting devices with a micromixer on a single microfluidic chip. This two-step sorting scheme enables a) to purify the binary-sorted sample by running the same sorting process twice or b) to collect only those molecules of a desired pI-range, say pI 4˜pI 5, when the proteomic sample of interest contains several species within a broad pI range, e.g. pI 3˜pI 10. As proof of concept for this two-step sorting capability, we successfully sorted out pI marker 6.8 out of a mixture of three pI markers, 7.2, 6.8 and 5.5, as shown in FIG. 15.

Schematic of the continuous-flow two-step sorting approach. It allows sorting biomolecules of a specific pI range out of a complex mixture with a wide range of pI values. The sorting capability was demonstrated with collecting one pI marker (pI 6.8) out of a mixture of three pI markers (pI 7.2, 6.8 and 5.5). The coupling between the two sorting steps was realized in off-line mode with a manual titration.

It is possible to sort a sample mixture by integrating two sorting steps on a single chip using a micromixer. An example for this on-line coupling is shown in FIG. 16. Instead of a manual transfer and titration, the sample out of the first sorting step is titrated down to a desired pH value with a micromixer such as the zigzag-type mixer and is conveyed the second sorting channel and sorted again. The sorted samples are collected from three outlets. In this way, one can fractionate the sample into three pI groups and collect only those molecules which fall into a specific pI range, e.g. 4.5-6.2, as shown in FIG. 16.

The device was constructed as follows:

The device was prepared in one of two ways: Using a high-aspect-ratio negative photoresist such as SU-8, a 20 um thick (=channel height) layer was deposited, spin coated and then patterned with standard photolithography. After developing the exposed area, a positive master was obtained, which was used for molding with polymers such as poly(dimethylsiloxane), or PDMS. After curing in an oven at 60° C. for 3 hours, the PDMS sheet was fully cured and peeled off the SU-8 master. After punching the holes to connect the channels to the tubing, the PDMS sheet was plasma bonded with a glass cover (schematically depicted in FIG. 16A).

Another means of preparing the device is depicted in FIG. 16B. A positive photoresist was spin-coated, typically 1˜2 um thick, and then patterned using the standard lithography technique. The patterned resist was then used as a mask for the deep ion reactive etching in which the Si wafer was etched down to the desired channel height, in our case 20 um. After this dry etching process, the remaining photoresist layer was removed with pirahna solution. Subsequent molding process was the same as with the SU-8 master.

The overall dimensions of the device are shown in FIG. 16D. The device was approximately 22.2 mm×23.8 mm. The length of the first and the second sorting channel was roughly 2 mm long. The zigzag-type micromixer was 2 mm long and the angle is 45°. To obtain a higher mixing ratio, the overall length of the micromixer can be increased with a shallower angle

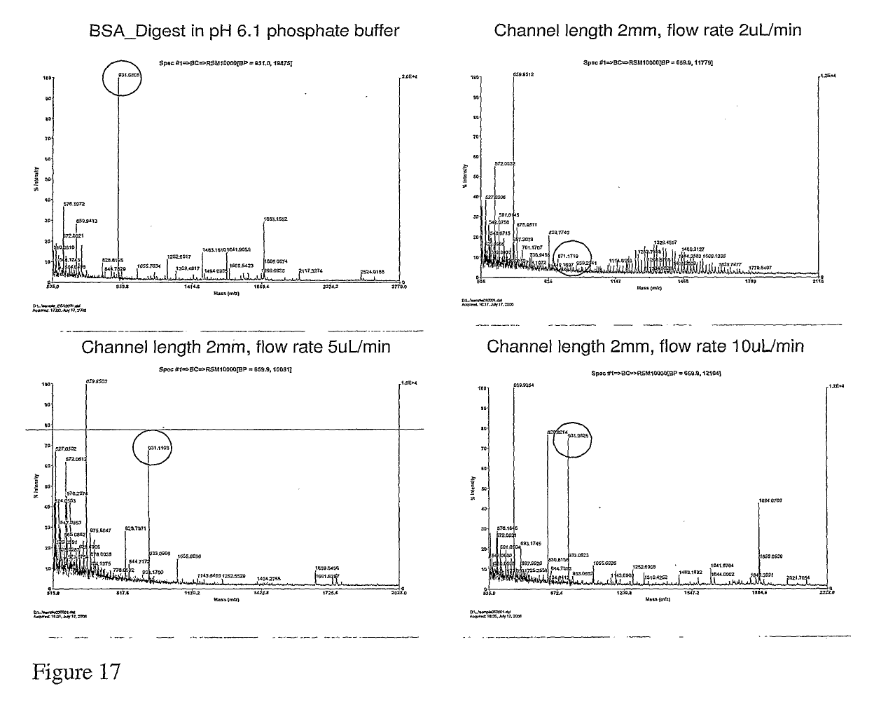

One embodiment of the application of a two-step sorting scheme outlined in FIG. 16C is the sorting of a complex BSA digest mixture which contains 82 different peptides within a pI range of 3-11. To investigate only those peptides, within pI 6˜pI 7, the two-step sorting approach was used. Preliminary results are shown in FIG. 17, obtained using the PSS as the sheath buffer. In a sample buffer with pH 6.1, the positive peptide with pI 6.8 (sequence: YLYEI AR) was completely removed from the sample, as the MALDI-MS analysis indicated. When the flow rate was increased from 2 uL/min to 10 uL/min, the concentration of the specific peptide increased which implied that the residence time was too short for the molecules to diffuse to the liquid junction. Using a PDDA sheath buffer, the negative peptide (sequence: YLYEI AR) was also completely removed from a sample buffer with pH 7.5. These results showed that if the two steps were combined successfully, one could collect peptides within a desired pI range, e.g. 6.1<pI<7.5, with a two-step sorting scheme.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. An apparatus for molecular sorting, the apparatus comprising:
a. a plurality of inlets, wherein at least one of said inlets serves for the introduction of a buffered solution comprising molecules, which differ in terms of their isoelectric point (pI) values, and at least a second inlet serves for the introduction of a second buffer, which differs from said buffered solution in terms of its pH or salt concentration, ionic species contained, solvent used, temperature, solvent viscosity, concentration of buffer additives, or combination thereof;
b. a plurality of outlets; and
c. a microfluidic chamber, in fluid communication with said inlets and said outlets;
whereby a diffusion potential is created in said chamber, enabling a charge-based separation of said molecules in buffered solution and said molecules which have undergone said charge-based separation may be collected via said outlets.

2. The apparatus of claim 1, wherein said apparatus comprises a non-conductive material.

3. The apparatus of claim 2, wherein said material is glass or PDMS.

4. The apparatus of claim 1, wherein said apparatus comprises a conductive or semi-conductive material.

5. The apparatus of claim 1, wherein said microfluidic chamber comprises an exposed surface which is transparent or semi-transparent.

6. The apparatus of claim 1, wherein the width of said microfluidic chamber ranges from 5-1000 μm, the length of said microfluidic chamber ranges from 500 μm-8 mm, and the depth of said microfluidic chamber ranges from 1-100 μm.

7. The apparatus of claim 1, wherein said second buffer and said buffered solution differ in terms of their pH values and the isoelectric point (pI) values of said molecules range between said pH values.

8. The apparatus of claim 1, wherein said second buffer and said buffered solution have the same pH value and the isoelectric point (pI) values of said molecules are above or below said pH value.

9. The apparatus of claim 8, wherein said second buffer and said buffered solution differ in terms of their salt concentration.

10. The apparatus of claim 1, wherein said buffered solution or said second buffer comprise at least one ion in common, which differs in terms of its diffusivity.

11. The apparatus of claim 1, further comprising electrodes and a means of applying voltage, wherein said electrodes are so positioned such that following application of voltage, an electric field is generated, which is coincident with the field generated by said diffusion potential.

12. The apparatus of claim 11, wherein said voltage applied generates an electric field with field strength of up to 3.5×10⁴ V/m.

13. The apparatus of claim 1, wherein said buffered solution is flowed through said chamber at a relatively constant flow rate.

14. The apparatus of claim 13, wherein said flow rate ranges from about 0.5-15 μl/minute.

15. The apparatus of claim 1, wherein said isoelectric point (pI) values may differ by about 0.005.

16. The apparatus of claim 1, wherein said second buffer comprises a polyelectrolyte solution.

17. The apparatus of claim 1, wherein said apparatus further comprises at least a second microfluidic chamber in fluid communication with inlets and outlets, wherein an outlet of a first chamber serves as a conduit for introducing a buffered solution comprising molecules, which differ in terms of their isoelectric point (pI) values into an inlet of said second microfluidic chamber.

18. The apparatus of claim 17, wherein said apparatus comprises a plurality of microfluidic chambers.

19. The apparatus of claim 18, wherein said microfluidic chambers are stacked in series.

20. The apparatus of claim 18, wherein said microfluidic chambers are stacked in parallel.

21. The apparatus of claim 18, wherein each microfluidic chamber is loaded with buffers, which differs in terms of their pH range.

22. The apparatus of claim 17, further comprising an inlet into said conduit for introducing an acidic solution.

23. The apparatus of claim 17, further comprising a micromixer.

24. The apparatus of claim 23, wherein said micromixer comprises inlets, which convey said buffered solution and said acidic solution into said micromixer, and an outlet which conveys the mixed solution to said second microfluidic chamber.

25. The apparatus of claim 1, further comprising an imaging device.

26. The apparatus of claim 1, further comprising an analytical device.

27. A method of separating molecules in a sample, based on differences in their isoelectric point (pI), the method comprising:
a. introducing a buffered solution comprising molecules, which differ in terms of their isoelectric point (pI) values into an inlet of an apparatus for molecular sorting, the apparatus comprising:
i. a plurality of inlets;
ii. a plurality of outlets; and
iii. a microfluidic chamber, in fluid communication with said inlets and said outlets;
b. introducing into a second inlet in said apparatus a second buffer, which differs from said buffered solution in terms of its pH, salt concentration, ionic species contained, solvent used, temperature, solvent viscosity, concentration of buffer additives, or combination thereof;
c. applying a constant pressure to said buffered solution and said second buffer; and
d. collecting separated molecules from at least one outlet of said chamber;
whereby a diffusion potential created in said chamber at the interface between said buffered solution and said second buffer enables charge-based separation of said molecules in buffered solution, such that molecules of a particular pI range concentrate at regions of said microfluidic chamber in alignment with an outlet of said chamber.

28. The method of claim 27, wherein said apparatus comprises a non-conductive material.

29. The method of claim 28, wherein said material is glass or PDMS.

30. The method of claim 27, wherein said apparatus comprises a conductive or semi-conductive material.

31. The method of claim 27, wherein said microfluidic chamber comprises an exposed surface which is transparent or semi-transparent.

32. The method of claim 27, wherein the width of said microfluidic chamber ranges from 5-1000 μm, the length of said microfluidic chamber ranges from 500 μm-8 mm, and the depth of said microfluidic chamber ranges from 1-100 μm.

33. The method of claim 27, wherein said second buffer and said buffered solution differ in terms of their pH values and the isoelectric point (pI) values of said molecules range between said pH values.

34. The method of claim 27, wherein said second buffer and said buffered solution have the same pH value and the isoelectric point (pI) values of said molecules are above or below said pH value.

35. The method of claim 34, wherein said second buffer and said buffered solution differ in terms of their salt concentration.

36. The method of claim 35, wherein said buffered solution or said second buffer comprise at least one ion in common, which differs in terms of its diffusivity.

37. The method of claim 27, wherein said second buffer comprises a polyelectrolyte solution.

38. The method of claim 27, wherein said molecules are concentrated at an interface between said buffered solution and said second buffer when said molecules comprise pI values, which are in between the pH values of said solutions.

39. The method of claim 27, wherein said molecules are depleted from an interface between said buffered solution and said second buffer when said molecules comprise pI values, which are greater or lesser than the pH values of said solutions.

40. The method of claim 27, wherein said apparatus further comprises electrodes and a means of applying voltage, wherein said electrodes are so positioned such that following application of voltage, an electric field is generated, which is coincident with the field generated by said diffusion potential.

41. The method of claim 39, wherein said voltage applied generates an electric field with field strength of up to 3.5×10⁴ V/m.

42. The method of claim 27, wherein said pressure creates a relatively constant flow rate in said buffered solution.

43. The method of claim 41, wherein said flow rate ranges from about 0.5-15 μl/minute.

44. The method of claim 27, wherein said isoelectric point (pI) values may differ by about 0.005.

45. The method of claim 27, wherein said apparatus further comprises at least a second microfluidic chamber in fluid communication with inlets and outlets, wherein an outlet of a first chamber serves as a conduit for introducing a buffered solution comprising molecules, which differ in terms of their isoelectric point (pI) values into an inlet of said second microfluidic chamber.

46. The method of claim 45, wherein said apparatus comprises a plurality of microfluidic chambers.

47. The method of claim 46, wherein said microfluidic chambers are stacked in series.

48. The method of claim 46, wherein said microfluidic chambers are stacked in parallel.

49. The method of claim 45, wherein each microfluidic chamber is loaded with buffers, which differs in terms of their pH range.

50. The method of claim 45, further comprising an inlet into said conduit for introducing an acidic solution.

51. The method of claim 45, further comprising a micromixer.

52. The method of claim 45, wherein said micromixer comprises inlets, which convey said buffered solution and said acidic solution into said micromixer, and an outlet which conveys the mixed solution to said second microfluidic chamber.

53. The method of claim 27, wherein said molecules are labeled with a detectable marker.

54. The method of claim 27, wherein said apparatus further comprises an imaging device.

55. The method of claim 27, wherein said apparatus further comprises an analytical device, which is so positioned such that an outlet of a microfluidic chamber conveys separated molecules to said analytical device.
